(19) United States
(12) Patent Application Publication
(10) Pub. No.: US 2003/0023677 A1
(43) Pub. Date: Jan. 30, 2003

(54) On-line project collaboration system

(76) Inventors: Graham Morison Zuill, New York, NY (US); Michael Austin Hinchcliffe, New York, NY (US); Michael Martin Wathen, New Canaan, CT (US); John Boyd Carson, New York, NY (US)

Correspondence Address: FISH & RICHARDSON P.C., 45 ROCKEFELLER PLAZA, SUITE 2800, NEW YORK, NY, 10111, US

(21) Appl. No.: 10/202,237

(22) Filed: Jul. 24, 2002

Related U.S. Application Data
(60) Provisional application No. 60/307,718, filed on Jul. 25, 2001.

(51) Int. Cl. G06F 15/16

(52) U.S. Cl. 709/203; 709/206

(57) ABSTRACT

A system provides an on-line project area. The project area includes respective private areas for entities participating in the project. Each private area is accessible and controllable only by participants from an entity associated with that private area. The project area includes a shared area that is accessible to all participants. A determination regarding whether and to whom information from a particular private area is to be shared is based on permissions established according to a distributed system in which each participant independently can control sharing of objects owned by that participant from the participant's private area to the shared area.

### CROSS-REFERENCE TO RELATED APPLICATIONS

This application claims the benefit of priority of U.S. Provisional Patent Application No. 60/307,718, filed on Jul. 25, 2001.

### BACKGROUND

This disclosure relates to an on-line project collaboration system.

Companies and other organizations constantly struggle with the need to share information and manage projects, and then ensure that the key findings from the projects are captured and reflected in the company's future business processes. These problems may be more acute when people from multiple organizations are involved in a project. For example, when one corporate entity is involved in the purchase of another corporate entity, a number of other companies such as investment banks, law firms, accounting firms and others may participate in various aspects of the transaction as well. At any particular time, each company may be involved with a broad range of projects, some of which involve collaboration with other entities, and some of which are internal to the specific company and do not require external collaboration.

### BRIEF DESCRIPTION OF THE DRAWINGS

FIG. 1 illustrates the architecture of a computer-based system that allows organizations to collaborate on a project.

FIG. 2 illustrates the structure of an on-line project area.

FIG. 3 illustrates the overall structure of project areas for different teams.

FIG. 4 illustrates an example of a participant's personal homepage.

FIG. 5 illustrates an example of a project homepage.

FIGS. 6-13 illustrate examples of on-line screens associated with a particular project.

FIG. 14 illustrates an example of the structure of a project area for the purchase side of a corporate transaction.

FIG. 15 illustrates an example of the structure of a project area for the sell side of a corporate transaction.

### SUMMARY

In general, a system is disclosed that provides an on-line project area. The project area includes respective private areas for entities participating in the project. Each private area is accessible and controllable only by participants belonging to an entity associated with that private area. The project area includes a shared area that is accessible to all participants. A determination regarding whether and to whom information from a particular private area is to be shared is based on permissions established according to a distributed system in which each participant independently can control sharing of objects owned by that participant from the participant's private area to the shared area.

One or more of the following features may be present in some implementations. For example, the owner of an object may specify which participants in the project are to be given access to the object in the shared area and to specify levels of access the other participants are to be given with respect to the shared object.

User interfaces may include a personal homepage for each participant accessible through the network. The computer system may allow a participant to create a new project area through the participant's personal homepage and to establish access permissions through the participant's personal homepage. The personal homepage may provide access to a project homepage that includes a toolbar to allow the participant to create and view issues, action items, alerts or other objects relating to the project. Each private area may include an on-line workroom for creating, accessing and sharing objects.

Participants may invite other persons or organizations to join a project and to be given access to the shared area.

References to a project area, private area or shared area being “accessible” or “inaccessible” should be understood as meaning that those areas are accessible or inaccessible by persons using or attempting to use the system as authorized in accordance with access permissions properly established by the system. Those terms and similar terms, as used in this document, do not take into account improper, unauthorized or illegal attempts to access the system or areas of the system.

Various implementations may include one or more of the following advantages. The system may help facilitate collaboration, project management, information sharing and knowledge management among various corporate and other entities. The system may also allow users to maintain full confidentiality about their activities, but also allows users to collaborate on specific tasks and share specific, designated information.

By facilitating the process by which individuals may be invited to participate in the project, the system can provide greater control over the project to the participants. Similarly, the use of individual and group-based permissions allows users to control and manage the confidentiality and sharing of their information. Distributed administration of access permissions also can give users greater control over the project by allowing the owner of an object, such as a document, to control and specify whether the object is to be shared, which participants will have access to the shared object and what level of access each participant or group of participants will have to the shared object.

Additional aspects and other features and advantages will be readily apparent from the following detailed description, the accompanying drawings and the claims.

### DETAILED DESCRIPTION

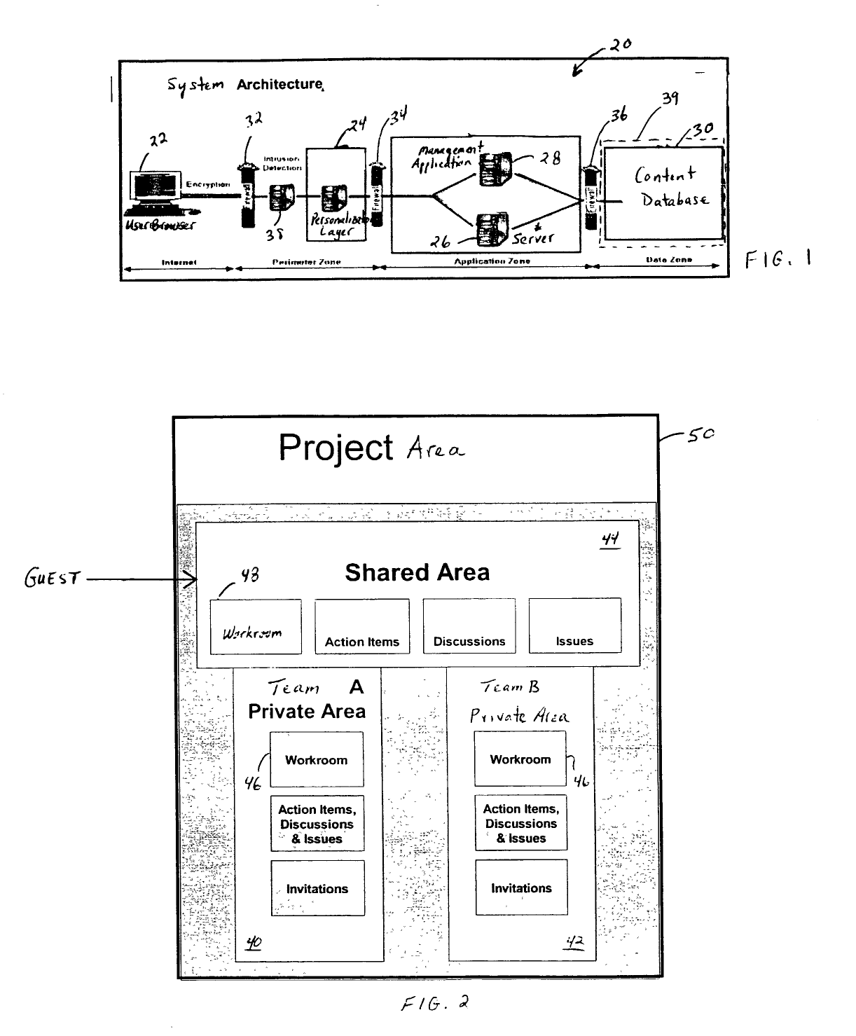

FIG. 1 illustrates an example of a computer-based system 20 for the electronic distribution and storage of corporate and other information. The system may help facilitate collaboration, project management, information sharing and knowledge management among various corporate and other entities. The system may be Internet-based and is designed to provide these capabilities to multiple users of the system simultaneously, independently and in conjunction with each other.

As shown in FIG. 1, the system 20 includes user devices, such as the personal computer 22 with a web browser, to enable access to the Internet or other computer network. Although only a single personal computer 22 is illustrated in FIG. 1, the system 20 is designed to allow multiple users to access and use the system. Thus, each user may have his own personal computer or other device that is connected to the network. A personalization layer 24 can process information from the user, check whether the user is authorized to use the system, collate information from other components of the system and transmit that information to the user as a webpage.

A server 26, such as a Lightweight Directory Access Protocol (LDAP) server, stores a directory of user names and associated rules. An application, including software instructions, may be stored on a machine-readable medium and may be executed on a machine such as a computer 28 to allow the system to provide various management functions, including project collaboration and knowledge management. A content database 30 stores objects, such as documents, issues, action items and other information, that relate to various projects in which the users may be involved.

To reduce the risk of unauthorized access, the system 20 may include one or more firewalls 32, 34, 36, as well as intrusion detection capabilities 38 and database encryption and system administration access control capabilities (39). Information may be transmitted across the Internet, for example, using 128-bit Secure Socket Layer (SSL) or other encryption technology.

As described in greater detail below, the system allows multiple companies or other entities to manage their projects in a confidential manner, and, at the same time, allows participants to make their use visible to each other and to use the system to work together on one or more specific projects. Individual and entity-based permissions allow a user to control and manage the confidentiality and sharing of the user's information.

A particular project, such as a corporate transaction, may have multiple participants from different companies or other organizations. Each project is associated with its own project area that may have one or more private areas and a shared area associated with it. A project area corresponds to computer resources, such as memory in the content database 30, that may be used for the particular project. Each team participating in the project is from a different organization and is assigned its own secure, private area. A particular private area is only accessible to and controllable by participants from the specific organization. In a project area, participants can share, manage and search documents, define and manage tasks and issues, have conversations in threaded discussions and broadcast news and events. Such objects are included within the project area and are not available to persons outside the project area.

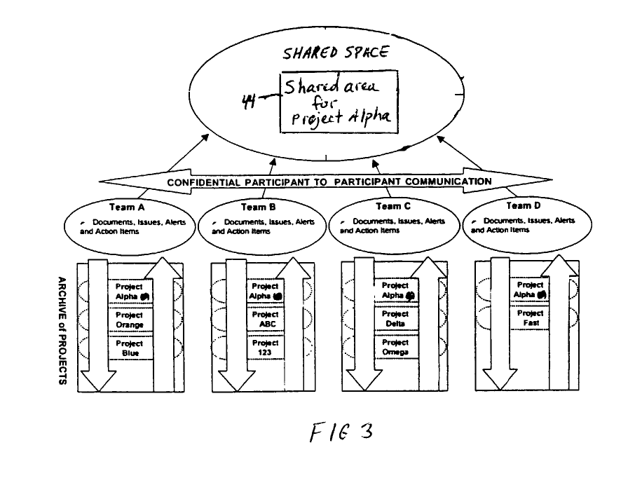

For example, as shown in FIG. 2, team A has a private area 40, and team B has a different private area 42 within project area 50. Although FIG. 2 shows only two private areas, more than two teams may be involved in a particular project with each team having its own on-line private area. Activities and information in a particular team's private area are inaccessible to members of other teams working in other private areas. However, some or all of those activities and information may be designated to be shared with other teams, or with specific participants from the other teams, through an on-line shared area 44.

Each private area may include a secure, on-line workroom 46 through which team members can work on their projects and documents and control who can access them. The workroom 46 allows team members, for example, to create, import, access and edit their documents. In addition, team members can share some or all of their documents with one or more other teams through the shared area 44. The team member who chooses to share particular documents can designate the level of access that members of other teams have for each document. Shared documents may be accessed by other participants to whom permission is granted through a shared workroom 48 in the shared area 44.

Each private area 42, 44 also may include other objects such as action items, issues and discussions which are accessible only to participants who have access to that private area. Team members can create, categorize and set priorities for issues relating to the project, as well attach or provide a link to supporting documents. Similarly, team members can create, assign and track the status of action items in connection with their projects. In addition, team members can select any or all of the action items, issues and discussions to be shared with members of other teams through the shared area 44.

The system also provides distributed administrative features that allow participants in a project to invite new users into a particular project area. Invitations may be extended from the private areas 40, 42 as discussed in greater detail below. As also discussed below, certain invitees may be granted access to the shared area for a particular project, but may not have their own private areas. The distributed administration also allows project participants to create sub-groups of participants, consisting of users either from within the user's own organization or from multiple organizations. Objects can then be shared to those sub-groups. Groups can either be closed such that only existing members may invite new members, or open such that all participants can invite themselves or others to the group.

As illustrated in FIG. 3, each team may have one or more projects associated with it. For example, team A has projects “Alpha,” “Orange” and “Blue”, whereas team B has projects “Alpha,” “ABC” and “123.” All four teams are participants in project “Alpha.” Therefore, each team may use either its own private area or the shared area for tasks associated with project “Alpha” depending on whether the corresponding object (e.g., document) is shared or not shared. The system allows confidential communications among participants, and allows the participants to use the shared area for collaboration on a project, project management, knowledge sharing and quick access to information that other teams may choose to share.

A particular team may collaborate with one team on a first project and with a second team on another project. Each project is assigned its own shared area 44 of the system's on-line shared space. Thus, participants may collaborate with participants from other teams, communicate efficiently, share information and issues, and more effectively manage multiple projects in a secure environment. Each team may consist of different users in an organization. However, project spaces are accessible and visible only to user's who have been granted access.

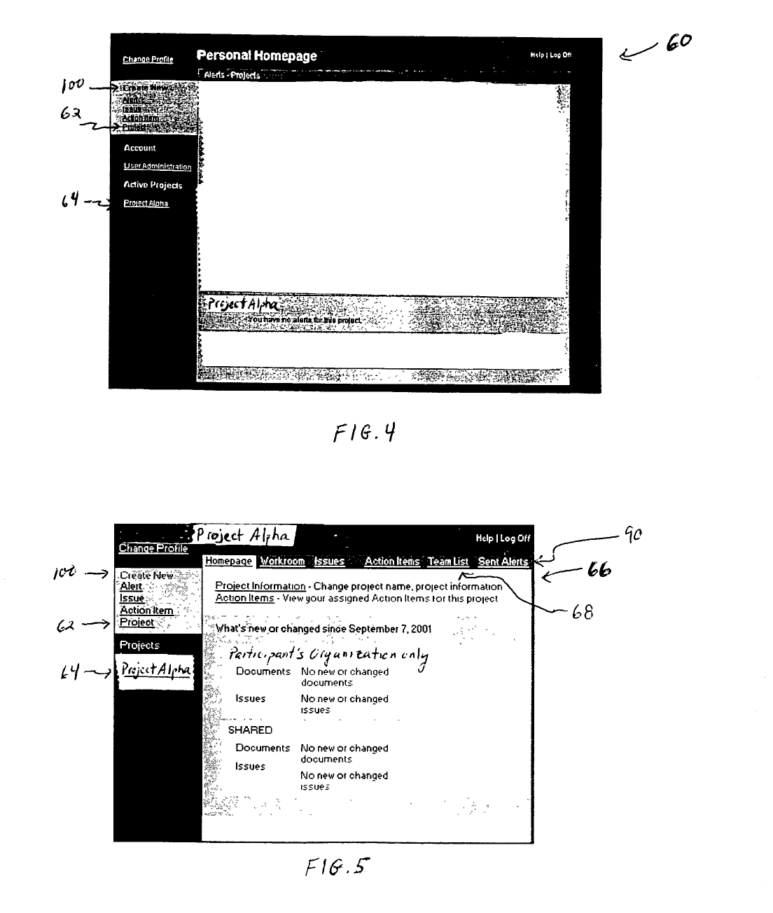

Each organization may assign its users different roles, each of which may have permitted functions. In one particular implementation, registered users of the system may include administrators, coordinators, and members. Such users may belong to an account and may be considered subscribing users. Each user has a personal homepage, such as the homepage 60 shown in FIG. 4, which can be accessed, for example, from the user's personal computer through the Internet. The personal computer or other device, together with the user's personal homepage, serves as a user interface that allows the user to take certain actions with respect to the project area.

An administrator has the ability to create new users for an account to which the administrator belongs. An account is a logical and mutually exclusive group of users within an organization. Thus, a particular organization, such as a company, may have one or more accounts with the system. The administrator assigns the role for each user (e.g., coordinator, member, or guest) and decides whether to grant that user the rights of an administrator. The administrator also can suspend a user's role or administrator rights and can deactivate the account to which the administrator belongs.

A coordinator has the ability to initiate the creation of a new project area, for example, by clicking on the Project link 62 under the heading “Create New” in the coordinator's personal home page 60 (see FIG. 4). The system prompts the coordinator to enter information about the project. Based on that information, the system captures meta data about the project and sets up folders defined by the coordinator for both the associated private area as well as the shared area. By clicking the link 64 for the particular project (e.g., Project Alpha), a homepage 66 for the particular project appears on the user's computer screen (see FIG. 5). The homepage 66 may include a navigation tool bar 90. Although FIG. 4 lists only a single project, a user typically may participate in more than one project. A separate link to the corresponding project page would be provided for each project.

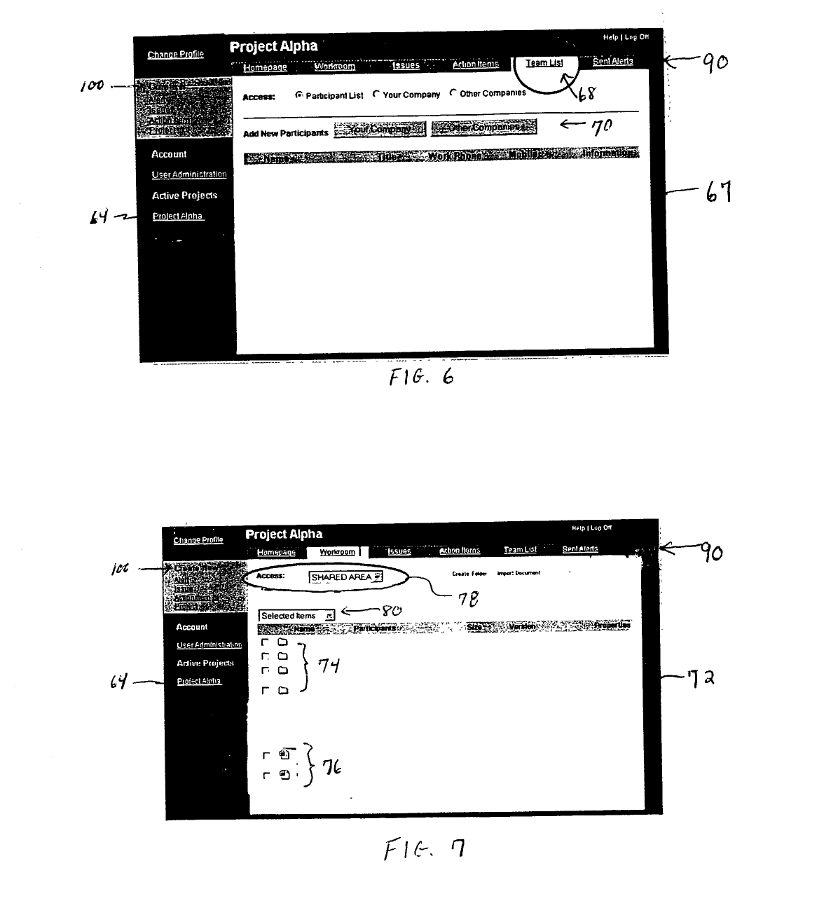

A coordinator can extend invitations to other persons to participate in the project by clicking the Team List tab 68, and then clicking on one of the buttons 70 on the screen 67 (FIG. 6) to add new participants and identifying the electronic mail address of the persons(s) to be invited. Invitations to join a project may be extended to individual users or to a group of users. In response, the system automatically sends an electronic mail message to each invitee inviting that person to join the project as a participant.

If the organization to which an invitee belongs has not yet been assigned a private area for the particular project (and assuming that the organization has an account with the system), then the system automatically creates the private area when the invitee accepts the invitation by accessing his personal homepage and clicking on the link 64 to the project. On the other hand, if the organization already has a private area for the particular project, then the person is simply added as a participant to the project when the invitee accesses his personal home page. The names and other information about the participants in the project may be listed, for example, in the lower portion of the page 67 (FIG. 6).

In contrast to the rights of a coordinator, members cannot initiate creation of a project area. However, a member has the ability to invite other users to the project area. In general, a member has access to his organization's private area as well as the ability to navigate to the shared area for the particular project.

Guest users may be invited to join a project. However, in the particular implementation described here, guest users do not have the ability to create a new project area and cannot invite other users to the project area. Upon accepting an invitation to join a project area, the guest is added as a participant of that project area. In some implementations, guest users are not given a separate on line private area; instead, they have access only to the on-line shared area 44 (FIG. 1) for the particular project to which they are invited.

The foregoing roles are intended as examples. In other implementations, users may be assigned additional or different roles.

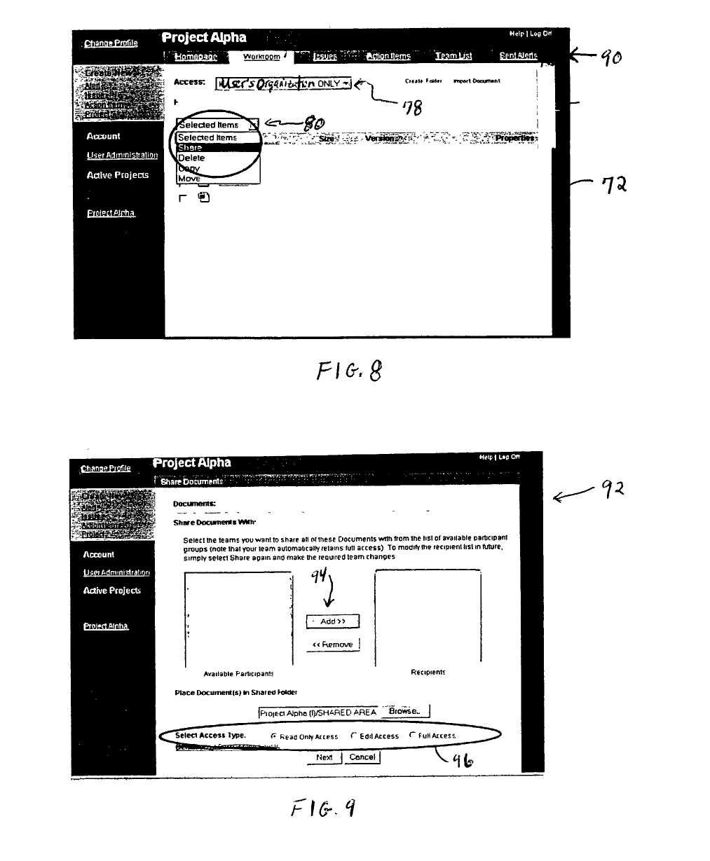

A participant may access, import, export, edit and create objects, such as folders, documents, issues, action items, universal resource locators (URLs) and alerts from the project homepage accessed from the participant's personal homepage. For example, by clicking on the Workroom tab 72 (FIG. 7), a user can access folders 74 and documents 76 in his organization's private area or the shared area. To facilitate identifying which objects have been shared with other teams, the workroom may be split into two views: a private workroom and a shared workroom. Using a drop-down menu 78, the user can select to view a list of the objects either in the shared workroom or the private workroom. FIG. 7 illustrates a screen when the user selects the shared workroom, whereas FIG. 8 illustrates selection of the private workroom for the user's organization. Similar views may be provided for issues, action items and other objects.

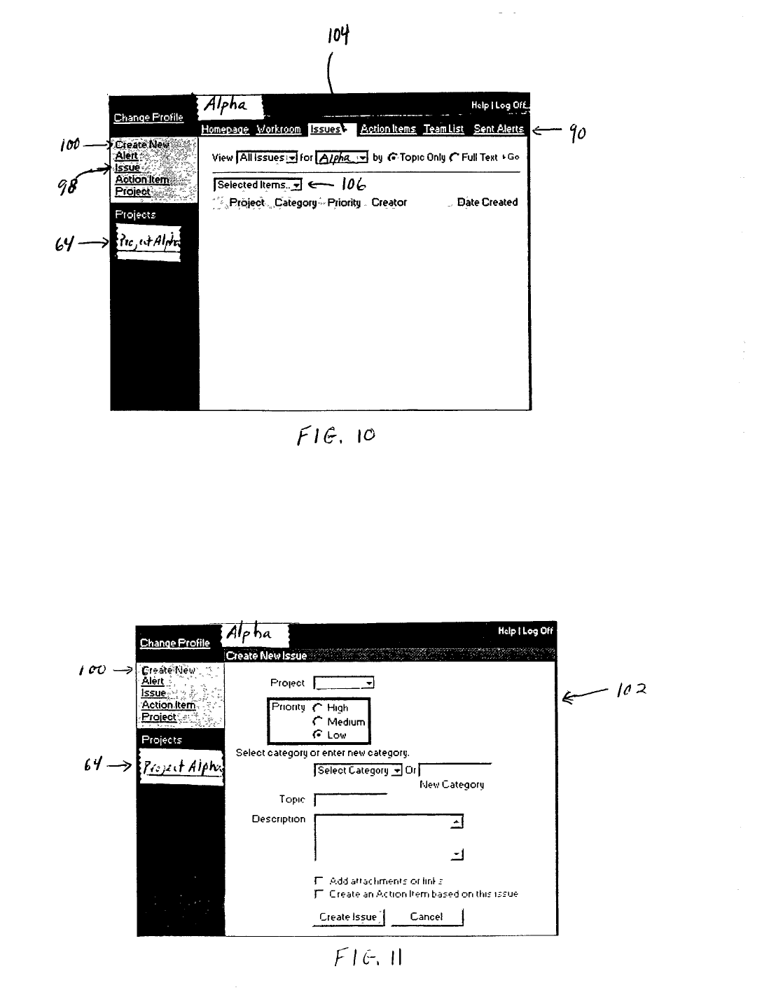

Another drop-down menu 80 (FIGS. 7 and 8) may be used to select one or more of the objects to be shared, deleted, copied or moved. If the user wishes to share one or more objects, then a share documents screen 92 (FIG. 9) appears which allows the user to modify the list of participants having access to the selected object(s) by using the tabs 94. The user also can select the level of access the other participants will have for the shared object(s) by clicking the appropriate boxes 96 for the desired access type. Examples of access levels include read-only, edit-only and full access.

Each participant can independently control the sharing of objects owned by that participant. Initially, the participant who creates an object may be considered the owner of that object. The creator of the object may share the object with other users, either within the user's own organization or with users from other organizations, and may grant those users “full-access” rights. In that case, those users also have ownership rights and can perform the same object management functions the original creator can perform, including removing the original creator's rights. On the other hand, if the object is shared with ‘read only” or “edit-only” rights, those users do not become owners of the object. Therefore, instead of centralized administration for specifying access permissions, the system provides for distributed administration to allow the owner of an object, such as a document, to control and specify whether the object is to be shared, which participants will have access to the shared object and what level of access each participant or group of participants will have to the shared object. A user with appropriate permissions may change the access levels.

A user can create a new issue by clicking on the Issues link 98 (see FIG. 10) under the heading “Create New” 100. A Create New Issue screen 102 (FIG. 11) appears and allows the user to complete various fields including the priority, topic and description of the issue. The user can select the appropriate boxes on the screen 102 to add attachments or links or create an action item for the new issue.

By clicking on the Issues tab 104 (FIG. 10) in the navigation tool bar 90, the user can view the various issues for the project by topic. Alternatively, the full text of the issues may be presented. The list indicates whether any of the listed issues are shared with other teams. Using the drop-down menu 106, the user can assign, monitor, share or update particular issues that relate to the project. For example, to share an issue, the user would select which issues to share and select “Share” from the drop-menu. Another screen would allow the user to select the participant groups, individuals or sub-groups with whom the user wishes to share the selected issue(s) and to control the level of access those participants have.

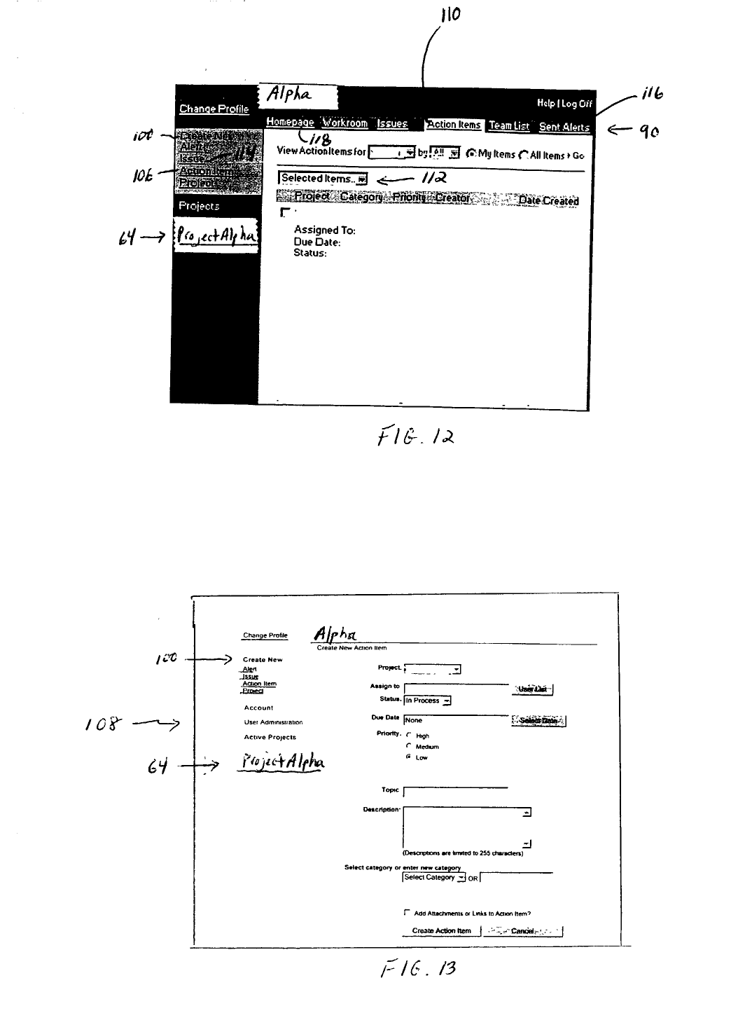

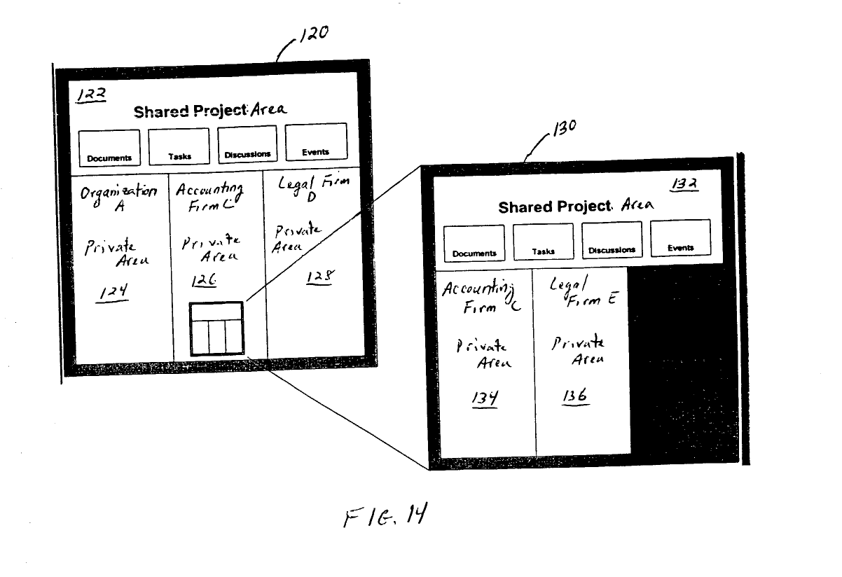

A user can create an action item by clicking on the Action Item link 106 (see FIG. 12) under the heading “Create New.” A Create New Action Item screen 108 (FIG. 13) appears and allows the user to complete various fields including the person assigned to the action item, the status and due date, as well as the priority, topic and description of the action item. The user can select the appropriate checkboxes to add attachments or links for the new action item.

By clicking on the Action Items tab 110 (FIG. 12) in the navigation tool bar 90, the user can view a list of selected action items. For example, the user may select to view action items for a particular project or for all projects. Similarly, the user may select to view a list of action items categorized, for example, by due date, author, priority, date created or status. In addition, the user may select to view only the action items for which he has responsibility or all action items to which he has access. The list may indicate whether any of the action items are shared with other teams and may indicate to whom the action item is assigned, the due date and the status of the action item.

Using the drop-down menu 112, the user can delete and share particular action items that relate to the project. For example, to share an action item, the user would select which action items to share and select “Share” from the drop-menu 112. Another screen would allow the user to select the participant groups with whom the user wishes to share the selected action item(s) and to control the level of access those participants have.

As previously discussed, the user that created a particular object, such as a document, an issue or an action item, can control the level of access that participants from other teams have to the object. Different levels of access may restrict the type of activities that a particular user may take with respect to the object. Thus, some users may be able to delete, share or edit an issue or action item, while others may be restricted, for example, to read-only access.

From the project homepage, a user also may create a new alert, or message, using the Alert link 114 (see FIG. 12) under the heading “Create New” 100. Alerts that have been sent by the user can be viewed by clicking on the Sent Alerts tab 116 on the navigation tool bar 90. Alerts sent to the user may be accessed from the user's personal homepage. The system also lists alerts addressed to the user on the user's personal homepage (see FIG. 4)

When a coordinator initially sets up a new project area, the coordinator may define the project as either “open” or “closed.” In an open project area, the default criteria is that users from all areas in that project area know about one another and about all participating organizations. In an open project area, users from all areas may be granted complete access rights, including read, write, delete, share, copy and download access with respect to objects in the shared area. Each participant is visible to other participants in the project space. In other words, each participant may be aware of all other participant's in the project.

In contrast, in a closed project area, the default is that all users in any particular area only know about the users in their own organization and in the area of the project's sponsor, which may be an individual or an organization. Users associated with the project's sponsor know about all users and participating organizations in the project area.

To illustrate how the foregoing on-line project collaboration system may be used, a scenario is discussed below in the context of the purchase and sale of a business. The scenario is intended as an example and the on-line collaboration system may be used in other contexts as well.

It is assumed that a potential buyer, Organization A, is interested in buying the XYZ business from the seller, Organization B. Organization A would like to have a secure, on-line environment in which it can store documents to share with personnel in its other offices, and for keeping track of tasks, discussions and events as they relate to this transaction. It is further assumed that Organization A wishes to request two external companies to assist it in the transaction: its accounting firm (Accounting Firm C) and its legal firm (Legal Firm D).

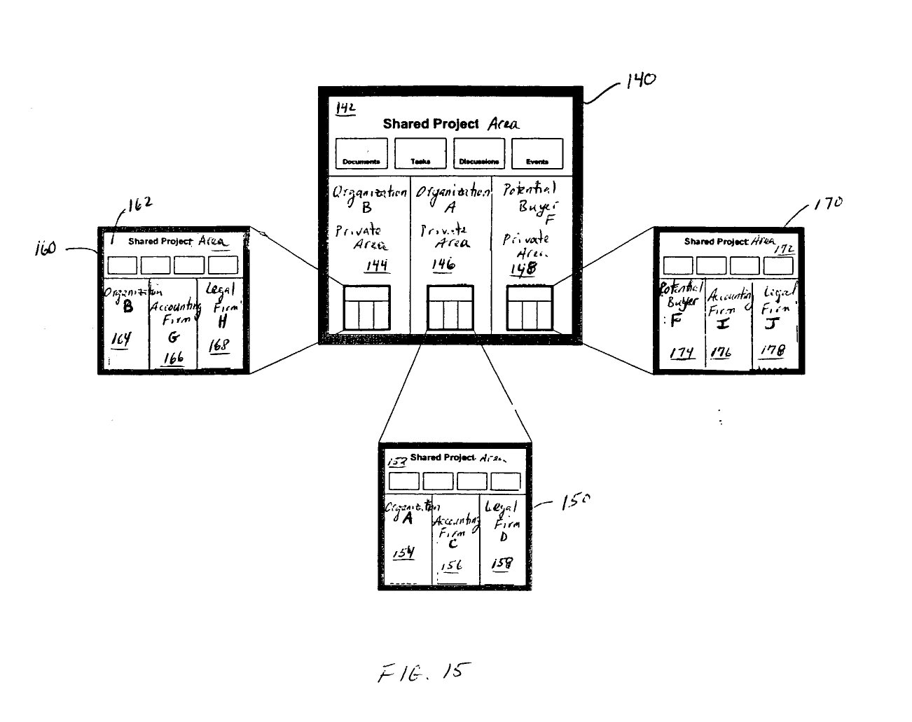

The potential buyer, Organization A, can use the project collaboration system to create an on-line project area 120 (FIG. 14) in which it is the sponsor and Accounting Firm C and Legal Firm D are participants. The project area in the example may be designated as “open” so that each of the participants has full access rights for the shared project area 122. As a result, Organization A, Accounting Firm C and Legal Firm D each has the ability to publish documents to the shared project area and to read documents in the shared project area depending on the permissions granted with respect to each document. Each organization also has its own private project area 124, 126, 128, respectively.

Once Accounting Firm D becomes involved in the process, it is assumed, in this example, that Accounting Firm D wants to involve its own legal firm, Legal Firm E, to advise it on various contract issues that relate to the purchase of the XYZ business of Organization B by Organization A. Accounting Firm C may create a new project sub-area 130 within its private area 126. That allows Accounting Firm C to interact with Legal Firm E in a secure, on-line environment, in the context of the overall transaction of project area 120, without involving the potential buyer, Organization A. Accounting Firm C and Legal Firm E have access to a shared area 132, and each has its own, respective, private area 134, 136. The shared area 132 may be designated as an “open” area to provide the legal Firm E with full access rights to the shared project area depending on the permissions granted for each object.

In another scenario, it is assumed that the seller, Organization B, knows that both Organization A and Potential Buyer F are interested in the purchase of its XYZ business. Organization B wishes to have a secure, on-line environment in which it can store documents that can be reviewed by either potential buyer, and an on-line space where it can negotiate privately with each buyer.

The seller, Organization B, can use the on-line system to create a project area 140 (FIG. 15) in which it is the sponsor, and Organization A and a company, Potential Buyer F, are participants. In this context, it may be assumed that each of the potential buyers (Organization A and Potential Buyer F) should remain unaware of the other and, therefore, the project area is designated as a “closed” area such that participants can only share objects with and receive objects from the project sponsor, not other participants. As a result, only the seller, Organization B, has the ability to publish to the shared project area 142. All three organizations, however, have the ability to read any document or other object from the shared project area 142, assuming Organization B grants the correct permission for the particular document or other object. Each organization also has its own, respective, on-line private area, 144, 146, 148.

Once it becomes involved in the transaction process, it is assumed that Organization A wants to involve its accounting firm (Accounting Firm C)) and its legal firm (Legal Firm D). Since this does not directly involve the seller (Organization B), Organization A may create a new project sub-area 150 within its private area 146. This allows Organization A to interact with its accounting firm (Accounting Firm C) and its legal firm (Legal Firm D) in a secure, on-line environment without having to involve the seller, Organization B. The project sub-area 150 has its own shared area 152, and private areas 154, 156, 158 for each of the participating organizations (Organization A, Accounting Firm C and Legal Firm 158).

Similarly, it is assumed that the seller (Organization B) wants to involve its accounting firm (Accounting Firm G) and its legal firm (Legal Firm H) in the transaction process. Organization B may create a project sub-area 160 within its private area 144. The project sub-area 160 has its own shared area 162 and private areas 164, 166, 168 for each of the participating organizations (Organization B, Accounting Firm G and Legal Firm H).

It also is assumed, in this example, that the other potential buyer (Potential Buyer F) wants to involve its accounting firm (Accounting Firm I)) and its legal firm (Legal Firm J) in the transaction process. Potential Buyer F may create a project sub-area 170 within its private area 148. The project sub-area 170 has its own shared area 172 and private areas 174, 176, 178 for each of the participating organizations (Organization F, Accounting Firm I and Legal Firm J).

Particular details of one implementation are set forth above. However, in other implementations, many details, such as the look and feel of the user interface, may vary.

Some implementations may include additional or different features. For example, users may have the ability to use the system as a searchable archive of all their project information. Users may be able to tag important, re-usable information and best practices. The system may populate a searchable table or database with information that can be searched by multiple users from within an organization regardless of the original project based permissions. The system may allow an organization to define and populate project space templates that individual users can select to be used with individual projects. In some implementations, the system may provide the ability to integrate multiple content providers such as company intranets, third-party research providers and internal customer relations management (CRM) databases into the platform.

In general, the on-line project collaboration system can allow users from various entities to maintain full confidentiality about their activities, but also allow users to collaborate on specific tasks and share specific, designated information.

The system has broad applicability in commercial and other projects. For example, it may be used to facilitate the development of new products where teams from a number of different organizations collaborate both within their organization and with each other to develop the new product. Other examples of use are in areas such as construction project management, new drug development initiatives and business integration projects following acquisitions or mergers.

Other implementations are within the scope of the claims.

What is claimed is:

1. An apparatus comprising:
a computer network;
a computer system coupled to the network and comprising an on-line project area corresponding to a project and accessible to participants in the project through the network, the on-line project area including respective private areas for entities participating in the project, wherein each private area is accessible and controllable only by participants from an entity associated with that private area, the project area further including a shared area accessible to all participants; and
user interfaces coupled to the network to allow each participant associated with a private area independently to control sharing of objects owned by that participant from the participant's private area to the shared area.

2. The apparatus of claim 1 wherein the user interfaces allow the owner of the object to specify which participants in the project are to be given access to the shared object in the shared area.

3. The apparatus of claim 2 wherein the user interfaces allow the owner of the object to specify respective levels of access other participants are to be given with respect to the shared object.

4. The apparatus of claim 1 wherein the user interfaces comprise a personal homepage for each participant accessible through the network.

5. The apparatus of claim 4 wherein the computer system allows a participant to create a new project area through the participant's personal homepage.

6. The apparatus of claim 5 wherein the computer system allows each participant to establish access permissions through the participant's personal homepage.

7. The apparatus of claim 4 wherein the computer system allows a participant in the project to request through the participant's personal homepage that a person associated with a different entity be invited to participate in a particular project area, wherein, in response to the request, the computer system automatically sends an electronic mail message to the invited person inviting that person to join the project as a participant.

8. The apparatus of claim 4 wherein the personal homepage provides access to a project homepage that includes a toolbar to allow the participant to view issues, action items and alerts relating to the project.

9. The apparatus of claim 8 wherein the project homepage includes links to allow the participant to create issues, action items and alerts relating to the project.

10. The apparatus of claim 1 comprising on-line project areas accessible to participants in a corresponding project through the network, each on-line project area including respective private areas for entities participating in the project and a shared area for the project, wherein objects in a particular project area are inaccessible to entities not participating in the particular project and, unless designated to be shared, objects in a particular entity's private area are inaccessible to entities not associated with that private area.

11. The apparatus of claim 1 wherein each private area includes an on-line workroom for creating, accessing and sharing objects.

12. An apparatus comprising:
a content database;
a computer coupled to the database, the computer including a computer-readable medium storing computer-executable instructions that, in response to user input, cause the computer to establish an on-line project area in the content database corresponding to a project, the project area comprising respective private areas for entities participating in the project and comprising a shared area for the project,
wherein activities and information in the project area are inaccessible to entities not participating in the project and, unless designated to be shared, activities and information in a particular entity's private area are inaccessible to entities not associated with that private area, and
wherein each participant associated with a private area independently can control sharing of objects owned by that participant from the participant's private area to the shared area.

13. The apparatus of claim 12 comprising a user interface to allow the owner of an object to specify which participants in the project are to be given access to the shared object through the shared area.

14. The apparatus of claim 13 wherein the user interface allows the owner of the object to specify respective levels of access participants are to be given with respect to the shared object.

15. The apparatus of claim 12 comprising a user interface to allow a user to control sharing of information from the user's private area according to individual or group-based permissions.

16. The apparatus of claim 12 comprising a user interface to allow a participant in the project to invite a person associated with a different entity into a particular project area, wherein, in response, the computer automatically sends an electronic mail message to the invitee inviting that person to join the project as a participant.

17. The apparatus of claim 16 comprising instructions to cause the computer to provide a respective personal homepage for each participant in the project to allow the participant to access a project homepage for a particular project.

18. The apparatus of claim 17 wherein participants can access the private areas and the shared through the project homepage.

19. The apparatus of claim 18 wherein, if an entity to which an invitee belongs has not yet been assigned a private area for the project, then, in response to the invitee's accessing his personal homepage and accessing a link to the project, the computer automatically establishes the entity's private area.

20. A method comprising:
providing an on-line project area corresponding to a project, the project area comprising respective private areas for entities participating in the project, wherein each private area is accessible and controllable only by participants from an entity associated with that private area, and the project area further including a shared area for the project, wherein the shared area is accessible to all participants; and
determining whether and with whom information from a private area is to be shared in the shared area based on permissions established according to a distributed system in which each participant independently can control sharing of objects owned by that participant from the participant's private area to the shared area.

21. The method of claim 20 including:
determining whether a particular object is to be accessible through the shared area according to input received from an owner of the object; and
setting permissions for access to the object based on the received input.

22. The method of claim 21 including:
determining which participants in the project are to be given access to the shared object according to the input received from the owner of the object; and
setting permissions for access to the object according to the determined participants.

23. The method of claim 22 including:
determining respective levels of access participants are to be given with respect to the shared object according to input received from the owner of the object; and
setting permissions for access to the object according to the determined level of access for each participant.

24. An article comprising a machine-readable medium storing machine-readable instructions that, when applied to the machine, cause the machine to:
provide an on-line project area corresponding to a project, the project area comprising respective private areas for entities participating in the project , wherein each private area is accessible and controllable only by participants from an entity associated with that private area, the project area further including a shared area for the project, wherein the shared area is accessible to all participants; and
determine whether and to whom information from a particular private area is to be shared in the shared area based on permissions established according to a distributed system in which each participant independently can control sharing of objects owned by that participant from the participant's private area to the shared area.

25. The article of claim 24 including instructions, that when applied to the machine, cause the machine to:
determine whether a particular object is to be accessible through the shared area according to input received from an owner of the object; and
set permissions for access to the object based on the received input.

26. The article of claim 25 including instructions, that when applied to the machine, cause the machine to:
determine which participants in the project are to be given access to the shared object according to the input received from the owner of the object; and
set permissions for access to the object according to the determined participants.

27. The article of claim 26 including instructions, that when applied to the machine, cause the machine to:
determine respective levels of access participants are to be given with respect to the shared object according to input received from the owner of the object; and
set permissions for access to the object according to the determined level of access for each participant.
